(19) United States
(12) Patent Application Publication
(10) Pub. No.: US 2001/0040979 A1
(43) Pub. Date: Nov. 15, 2001

(54) Compensating for color response and transfer function of scanner and/or printer when reading a digital watermark

(76) Inventors: Clay Davidson, Lake Oswego, OR (US); Alastair Reed, Lake Oswego, OR (US); Lixin Shen, Tualatin, OR (US); Jeremy Cattone, Tigard, OR (US)

Correspondence Address: ELMER GALBI, 13314 VERMEER DRIVE, LAKE OSWEGO, OR, 97035

(21) Appl. No.: 09/746,671

(22) Filed: Dec. 22, 2000

Related U.S. Application Data
(60) Provisional application No. 60/173,880, filed on Dec. 31, 1999.

(51) Int. Cl. G06K 9/00; G06K 9/40; H04N 1/00

(52) U.S. Cl. 382/100; 382/275; 358/406

(57) ABSTRACT

Watermark and pattern detection can be improved by compensating for artifacts introduced into an image by a printer and/or scanner through which the image has passed. With the present invention, prior to watermark or pattern detection, the image is filtered or modified to compensate for artifacts introduced by the printer and/or scanner. Some scanners automatically compensate for artifacts introduced by the scanner by using a calibrated tone map. The automatic compensation provides an image from which, a watermark can be easily read. However, generally the user is provided with an interface which can be used to change certain parameters such contrast and intensity. The changes made by the user change the compensation (i.e. the tone map) applied to the image. If the user changes the compensation applied to the image it can affect the ability to read the watermark. The present invention provides a system which reverses any compensation introduced by the user so that the watermark or pattern can be more easily read. In another embodiment the invention takes into consideration that some printers and scanners have transfer functions which differ in the “x” and “y” directions. Thus the compensation introduced by the filter can differ in the “x” and “y” directions. In one embodiment, a scanner introduces aliasing frequencies into an image. Detection is improved by selectively removing certain frequencies. In another embodiment, the filter compensates for fact that the scanner frequency response falls off at higher frequencies.

### RELATED APPLICATIONS

Priority is claimed based upon co-pending application Ser. No. 60/173,880 filed Dec. 31, 2000

### FIELD OF THE INVENTION

The present invention relates to steganography and more particularly to reading digital watermarks.

### BACKGROUND OF THE INVENTION

The technology for inserting digital watermarks in digital images and for reading digital watermarks from digital images is well developed. There are many issued patents and published technical papers which explain the technology for reading watermarks.

Frequently after a digital watermark has been inserted into a digital image, the image is printed and later the printed image is scanned to create a new digital image. However, printers and scanners do not precisely reproduce images. That is, printers and scanners introduce anomalies, distortions and changes into an image as it is being printed or scanned. The typical operations which are performed on watermarked images are illustrated in FIGS. 1A and 1B.

The process begins with a digital image 10A. An image editing program 11 is used to insert a digital watermark into the image. For example a watermark may be inserted into the image 10A by the watermark program which is part of the commercially available image editing program marketed by Adobe Corporation under the trademark “Adobe Photoshop”. Next, a printer 12 is used to create a physical image 10B which includes a digital watermark.

Next as illustrated in FIG. 1B, the physical image 10B is passed through a scanner 13 to generate a digital image 10C. The digital image is then processed by a watermark detection program 14 to detect the watermark. For example the watermark may be detected by the watermark detection program which is part of the commercially available image editing program marketed by Adobe Corporation under the trademark “Adobe Photoshop”.

Printer 12 and the scanner 13 generally do not have a perfect color response and they have transfer functions which is other than unity. That is, they introduce anomalies, distortions or changes into the image. For example, with some scanners, if a printed image is scanned and then displayed, the appearance of the displayed image will not be identical appearance to the hard copy image. Likewise, with some printers, if a digital image is printed, the printed image will not appear to be identical to a display of the original digital image. As used herein the term scanner is used to mean conventional flatbed and sheet feed scanners as well as other image acquisition devices such as digital cameras. Anomalies, distortions or changes introduced into an image by a printer or scanner are hereinafter collectively referred to as “artifacts”. Such artifacts may interfere with the operation of the watermark detection program 13 or with programs used to detect patterns or geometric shapes in an image.

Some watermark or pattern detection programs compensate for scale and rotation of an image. However, the prior art watermark and pattern detection programs do not adequately compensate for artifacts introduced into an image by a printer or scanner. Such artifacts can make detection of a digital watermark or pattern difficult if not impossible. This is particularly true when such artifacts are coupled with other changes such as scaling, rotation and wear and tear.

### SUMMARY OF THE INVENTION

Watermark and pattern detection can be improved by compensating for artifacts introduced into an image by a printer and/or scanner through which the image has passed. With the present invention, prior to watermark or pattern detection, the image is filtered or modified to compensate for artifacts introduced by the printer and/or scanner.

Some scanners automatically compensate for artifacts introduced by the scanner by using a calibrated tone map. The automatic compensation provides an image from which, a watermark can be easily read. However, generally the user is provided with an interface which can be used to change certain parameters such contrast and intensity. The changes made by the user change the compensation (i.e. the tone map) applied to the image. If the user changes the compensation applied to the image it can affect the ability to read the watermark. The present invention provides a system which reverses any compensation introduced by the user so that the watermark or pattern can be more easily read.

In another embodiment the invention takes into consideration that some printers and scanners have transfer functions which differ in the “x” and “y” directions. Thus the compensation introduced by the filter can differ in the “x” and “y” directions. In one embodiment, a scanner introduces aliasing frequencies into an image. Detection is improved by selectively removing certain frequencies. In another embodiment, the filter compensates for fact that the scanner frequency response falls off at higher frequencies.

### BRIEF DESCRIPTION OF THE FIGURES

FIGS. 1A and 1B show the process used in the prior art.

FIG. 2 illustrates a preferred embodiment of the invention using TWAIN interface.

FIGS. 3A and 3B are flow diagrams illustrating the operation of the present invention.

FIG. 3C shows the change in Gamma curve due to user setting.

FIGS. 4A and 4B show the process used in an alternate embodiment of the present invention.

FIG. 5A, 5B and 5C are used to describe an alternate embodiment of the invention.

FIG. 6 illustrates a technique for detecting the transfer function of a scanner and printer.

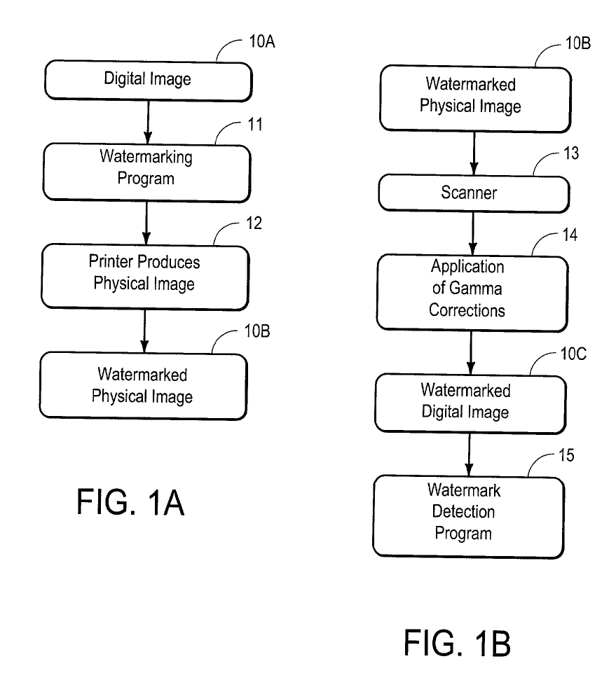

### DETAILED DESCRIPTION OF EMBODIMENTS OF THE INVENTION

The preferred embodiment of the invention described herein utilizes the invention to facilitate detecting and reading a digital watermark from an image. As explained later, the invention can also be used to facilitate the operation of other types of image analysis programs such as programs that detection geometric shapes, logos or other patterns. It is also noted that the preferred embodiment utilizes a scanner as an image acquisition device. Other types of image acquisition devices such as digital cameras could also be used with the present invention.

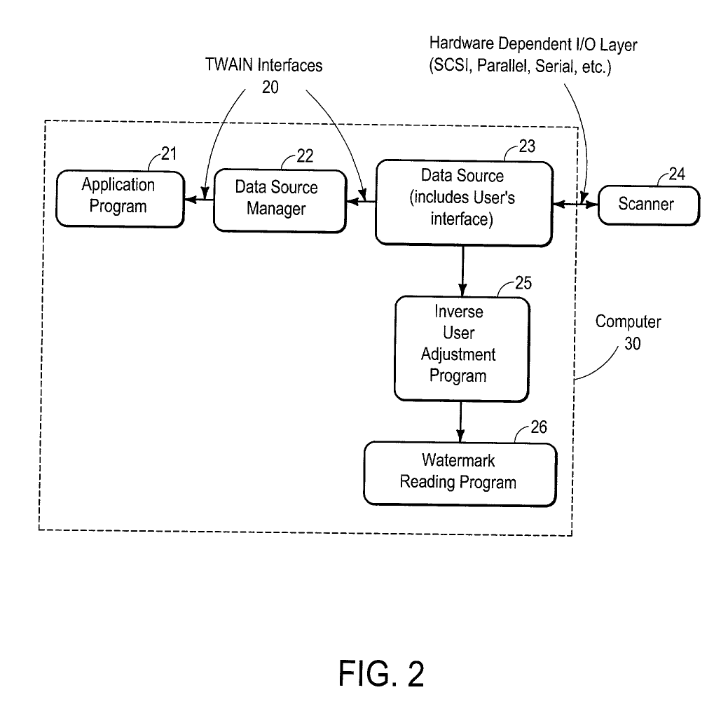

The first preferred embodiment of the present invention is shown in FIG. 2. The system shown in FIG. 2 includes a computer 30 and a scanner 24. In the particular embodiment described herein the scanner 24 is the Hewlett-Packard ScanJet model 6300c scanner (hereinafter HP 6300). The computer 30 can be a personal computer operating under the Microsoft Windows operating system.

The computer 30 includes an application program 21, and a watermark reading program 26. The application program 21 may, for example, be an image editing program such as “Adobe Photoshop” which is marketed by Adobe Corporation of San Jose Calif. The watermark reading program 26 may for example be similar to the watermark reading program which is included as a part to the Adobe PhotoShop program; however, as used here the watermark reading program 26 is separate from the application program 21.

The HP 6300 scanner uses what is known in the art as a “TWAIN” interface. The application program 21 is connected to a scanner 24 using a TWAIN interface 20. The TWAIN interface was developed by the TWAIN Working Group and it provides a standard software protocol and application programming interface (API) that regulates communication between software applications and imaging devices such as scanners.

Two key elements in a system that uses the TWAIN interface are the source manager software and the data source software. These elements are described in detail in the TWAIN specification which is available on the Internet at a site maintained by the TWAIN organization. This site can be located by doing an Internet search under the name TWAIN. The TWAIN specifications version 1.9 as ratified by the TWAIN working group on Jan. 20, 2000 is hereby incorporated herein by reference.

As shown in FIG. 2, the system includes data source manager software 22 data source software 23. The data source manager software 22 is a widely available program which provides an interface to a wide variety of imaging devices. The data source program 23 and the application program 21 have a TWAIN compliant interface to the data source manager 22. The data source program 23 provides a hardware dependent connection to the scanner 24. The HP 6300 is provided to users with a data source program which has a user interface, a TWAIN interface and a hardware interface to scanner 24. It should be appreciated that the invention can be applied to a large number of similar scanners. The present invention provides a modified data source program 23. Only those parts of the data source program 23 that are relevant to the present invention will be described herein. The remaining parts of the data source program 23 are conventional.

The data source software 23 communicates with the scanner 24 using a Scanner Control Language (SCL). This SCL language is described in a manual entitled “Scanner Control Language (SCL) and C Language Library for Hewlett-Packard Scanners v 11.0” which is published and distributed by Hewlett-Packard Corporation. This manual is hereby incorporated herein in its entirety and is hereinafter referred to as the scanner SCL Manual. Only those parts of data source program 23 that are relevant to the present invention are described herein.

A user interface provided by data source program 23 allows a user to change the tone and contrast of the image produced by scanner 24. The present invention is directed to insuring that changes made by the user do not interfere with the operation of the watermark detection program 26.

The scanner 24 includes a mechanism for providing a Gamma correction to the scanned image. The Gamma correction curve (i.e. an adjustment for the luminosity of each pixel in a scanned image) is controlled by a tone map which can be downloaded into the scanner by the data source program 23. In the scanner 24, the RGB values for each pixel are first adjusted in accordance the values in a 3 by 3 matrix which adjusts each color based on the values of the other colors of that pixel. Next the luminance value of each pixel is adjusted in accordance with a Gamma curve that specifies an adjustment for each particular luminance value. The term tone map as used herein refers to the values for the 3 by 3 matrix and the values which specify an appropriate adjustment for each luminance value (that is, the Gamma curve).

In the following discussion reference will be made to the following three tone maps:

1) Default tone map: a tone map stored in the printer that is used to adjust an image if no other tone map is provided to the printer.

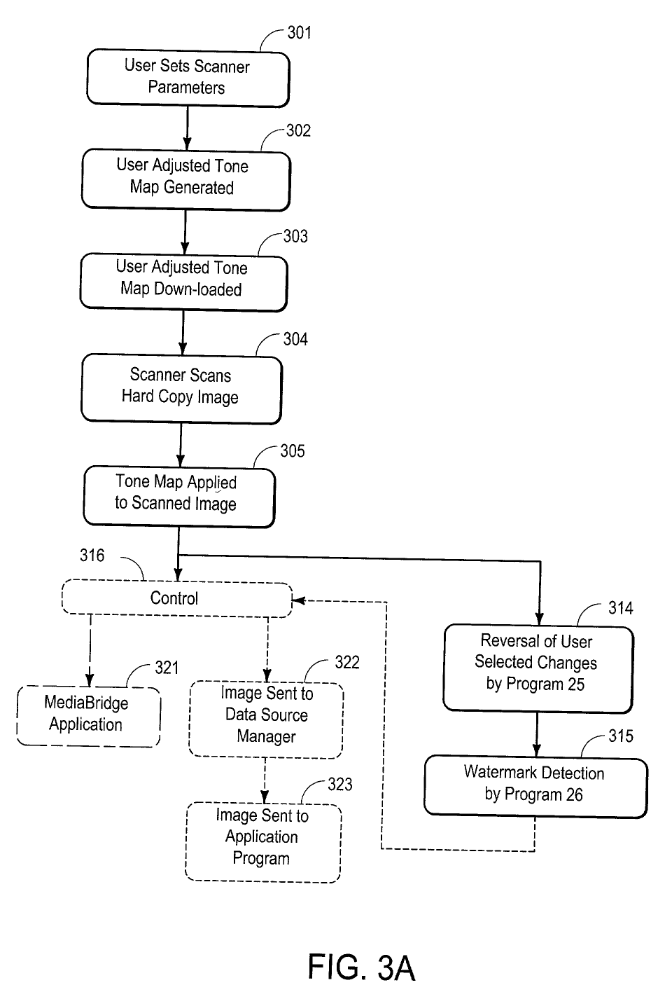

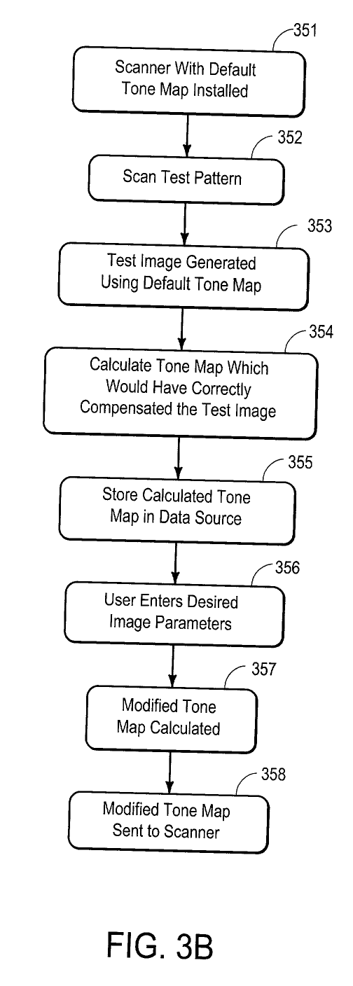

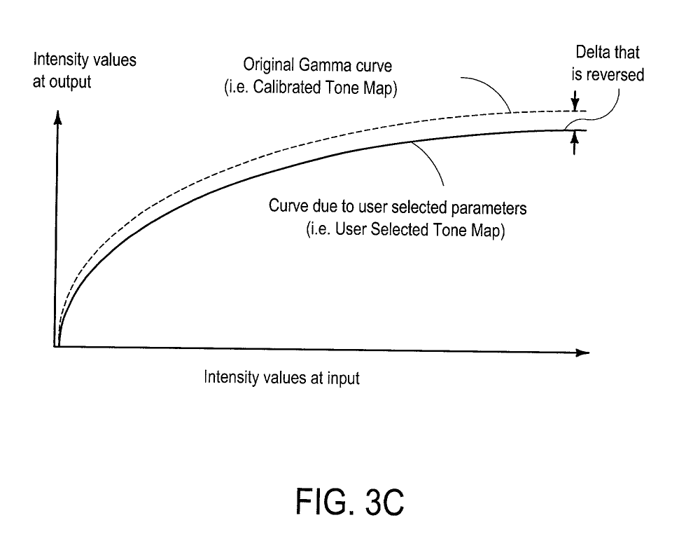

2) Calibrated tone map: a tone map which is generated from a test pattern and which is designed to produce, in so far as possible, a true digital representation of the scanned image. As used herein, the term a true digital representation means a digital image which when displayed appears identical to the original printed image that was scanned. A technique for generating a calibrated tone map is described later with reference to FIG. 3B.

3) User adjusted tone map: a tone map which is generated in response to user input to change an image so that the image has the contrast and intensity requested by the user.

The data source program 23 provides a conventional user interface through which a user can change the contrast and intensity of a scanned image. When a user changes the desired contrast and intensity of an image, the calibrated tone map is changed into the user adjusted tone map so that the image will have the user specified characteristics. This is a conventional operation which is preformed by the data source program that is provided with the HP6300 scanner.

When an image is scanned, the resulting digital data, corrected in accordance with the user adjusted tone map, is sent to the application program 21. The data is also sent to an inverse user adjustment program 25. The inverse user adjustment program 25 reverses any changes made to the image to satisfy the settings entered by the user. The output of the inverse user adjustment program 25 is a digital image that is identical to the digital image that would have been produced if the calibrated tone map had been applied to the image instead of the user modified tone map. The image as changed by inverse user adjustment program 25 is then sent to the watermark reading program 26.

The inverse user adjustment program 25 determines what changes were made to the calibrated tone map as a result of inputs from the user. Inverse user adjustment program 25 then applies the inverse of these changes to the image produced by scanner 24. The inverse user adjustment program 25 is a program that performs a inverse table look up operation. Programs to perform a inverse table look up are conventional. The action performed by inverse user adjustment program 25 is illustrated in FIG. 3C. When a user adjusts the contrast setting, the shape of the Gamma curve is changed. FIG. 3C illustrates what happens to the Gamma curve when the user adjusts the contrast of the image. In the example shown, the contrast setting was lowered by the user. As a result of the changes by the user the Gamma curve was changed and at the upper end (at higher intensity) the pixels are given a lower intensity than prior to the adjustment. The inverse user adjustment program 25 reverses the delta created by the user settings.

The following example illustrates the what occurs when the calibrated tone map is changed into a user adjusted tone map and how the inverse user adjustment program 25 operates.

Assume that the calibrated tone map has the following values (for convenience only a small section of the tone map is give).

Calibrated tone map values:

| | | | | | | | | | |
|---|---|---|---|---|---|---|---|---|---|
| Input | 251 | 252 | 253 | 254 | 255 | 256 | 257 | 258 | 259 |
| values | | | | | | | | | |
| output | 249 | 250 | 251 | 252 | 253 | 254 | 255 | 256 | 257 |
| values | | | | | | | | | |

Let us assume that due to inputs from the user, the following user adjusted tone map is generated (again only a small portion of the map is shown).

| | | | | | | | | | |
|---|---|---|---|---|---|---|---|---|---|
| Input | 251 | 252 | 253 | 254 | 255 | 256 | 257 | 258 | 259 |
| values | | | | | | | | | |
| Output | 248 | 249 | 250 | 251 | 252 | 253 | 254 | 255 | 256 |
| values | | | | | | | | | |

The inverse user adjustment program 25 would perform a reverse table look up as follows:

When, for example, it receives a value of 256, it would perform a reverse table look in the User Adjusted Tone map and determine that the 256 value came from an input value of 259. It would then adjust this value to 257 as specified by the calibrated tone map.

The operation of the system is illustrated in FIGS. 3A and 3B. FIG. 3A illustrates the normal operations that occur when an image is scanned. FIG. 3B illustrates the operations that are used to generate a calibrated tone map and to initialize the system. The operations shown in FIG. 3A normally take place each time the scanner is used to acquire an image. However, it should be noted that the operations illustrated in FIG. 3A take place after a calibrated tone map has been generated and stored in the data source 23 using the technique illustrated in FIG. 3B.

The operation of the system as illustrated in FIG. 3A will now be explained. As indicated by box 301 when a user wants to scan an image, the user sets the tone and intensity controls (or indicates that the defaults settings should be used). As indicated by block 302, the calibrated tone map is then changed to produce a user adjusted tone map (i.e. a tone map which will produce an image with the desired tone and intensity).

As indicated by block 303, the user adjusted tone map is sent to the scanner. As indicated by blocks 304 and 305, the image is then scanned and the scanner applies the user adjusted tone map to the digital data generated by the scanner. The image adjusted by the user adjusted image is herein termed an adjusted digital image.

As indicated by block 314, the adjusted digital image(i.e. the digital image with the user adjusted tone map applied) is supplied to the inverse user adjustment program 25. Program 25 reverses the changes made in the tone map to satisfy the user entered tone and contrast setting. The result is that inverse user adjustment program 25 produces a corrected image adjusted according to the calibrated tone map. As illustrated in FIG. 3C, the inverse user adjustment program 25 changes the image such that the result of both the correction made in the scanner and the correction made by inverse user adjustment program 25 (i.e. the sum of both corrections) is the same correction as would have been made by the calibrated tone map if only it had been applied to the image.

As indicated by block 315 the system sends the corrected digital image produced by inverse user adjustment program 25 to watermark reading program 26 which detects and reads the watermark. The watermark reading program 26 may be a conventional watermark reading program such as that which is a part of the commercially available “Adobe PhotoShop” program.

The invention is directed to enhancing the ability to read a watermark. Once the watermark is read, the data obtained can be used for a large variety of purposes. For example, once the watermark is read, the data from the watermark can be merely supplied to an operator or possibly to another program.

However, as indicated by dotted blocks 316, 321, 322 and 323, in one alternate embodiment, the output of the watermark detector 29 controls what data is sent to the data source manager 22 and to the application program 21. For example, if the watermark detector reads certain data, such as the name of the copyright owner, the name of the copyright owner along with the image corrected in accordance with the user adjusted tone map may be sent to the application program 22. Alternatively, if a different watermark is read, the image may not be sent to the application program. It can for example be used accesses a particular web site on the internet in accordance with the commercially available service market by Digimarc Corporation under the trademark “MediaBridge”.

In its simplest form the control indicated by block 316 can be implemented by a look up table that indicates what operation should be performed depending upon what particular watermark is detected. In the embodiment where the functions illustrated by blocks 316, 322 and 323 are performed, the transfer from data source 23 to data source manager 22 would be controlled by a gating mechanism which would only transfer the data from the scanner to the data source manager 22 and thus to the application program 21 depending on the output of watermark reading program 26. Alternate connections could be provided from data source manager 22 to other applications, again dependent upon the output of watermark reading program 26.

In still another embodiment, the output of the inverse user adjustment program 25 is both sent to a watermark reading program and to a shape recognition program. The combined output from both of the watermark reading program and the shape recognition program are then used to determine which operation should be taken.

FIG. 3B illustrates how the scanner is initialized, how the calibrated tone map is generated and how the user modified tone map is sent to the scanner. As initially installed the system uses a default tone map as indicated by block 351. The default tone map can be a very simple tone map with a straight line relationship between input and output, that is, a straight line Gamma curve.

Next, a test pattern and a calibration program is used to generate the calibrated tone map. The International Color Consortium has developed a standard color calibration format. Information about the standard color calibration can be found on a web site maintained by the Color Consortium. The web site has the name “color” and the group designator “org” (note URLs are not permitted in a patent application but the URL can be easily located from the above information)

The calibration technique uses a standard color calibration target to create a calibration profile for the scanner. The scanner is calibrated so that when a color calibrated target is scanned, the output will be a defined RGB output which faithfully reproduces the color calibrated target. Thus two scanners from different manufacturers which have been similarly calibrated will produce similar (if not identical) outputs from the same image.

As indicated by blocks 352 and 353, a test pattern is scanned and a test image is generated using the default tone map. A calibrated tone map, (that is, a tone map which would have produced an image which faithfully reproduced the test pattern) is generated as indicated by block 354.

There are commercial programs available which can be used to generate the calibrated tone map. A number of companies including Kodak, Fuji and ColorBlind Inc. provide calibration packages. The packages can be used for calibrating scanners, printers and monitors. Details of the calibration packages can be found at a web site maintained by Kodak corporation and at a web site with the name “itec” and the group designator “net” and at a web site with the name “ffei” and the designator “co.uk”

The calibrated tone map is stored in the data source program 23 as indicated by block 355. Next when a user wants to scan an image, the user may enter desired parameters such tone and contrast. In the preferred embodiment, the parameters entered include only tone and contrast; however, provision could be made to allow the user to adjust other additional parameters. For example, the user could be allowed to set the other color parameters such as hue, or the user could be allowed to set other parameters such as X Resolution, Y Resolution, X Scale factor, Y Scale factor, etc.

The resolutions may be of particular interest, since if there are *differing* resolutions or scale in the X and Y direction, it would be desirable to correct for this prior to attempting to detect the watermark. Resolution may be important since some watermark detectors cannot read watermarks if images have different resolutions in the X and Y direction. Also, if scale differs more than a few percent in X and Y it may make reading the watermark difficult. However, with the present invention if an image that has different sample rates or scale applied in X and Y directions, these can be adjusted prior to the watermark or pattern detection process.

Some scanners also have a “Set Filter” command for the scanner that controls how several pixels in the X direction may be averaged together to create a smoothed image. This command can be used to manually control the filtering. Also, some scanners have an “Inquire Auto-Filtering” command that lets the software ask the scanner what filtering in (in the X direction) is being used when the scan is done in the Auto-Filter mode. With the present invention, an awareness of what type of spatial filtering is being done, and the fact that it differs in the X and Y directions, could be used to either adjust and pre-compensate prior to detection, or could affect the operation of the detection algorithms.

As indicated by block 357, a user modified tone map which will produce an image with the desired characteristics is generated. The technique for generating a calibrated tone map from a test pattern and for altering a calibrated tone map in accordance with user entered parameters is known in the art. A “driver” which modifies a calibrated tone map in accordance with user entered parameters is provided by the manufacturer with many commercially available scanners. Finally as indicated by block 358, the user modified tone map is sent to the scanner and the process proceeds as indicated in block 303 in FIG. 3A.

The preferred embodiment of the invention described above relates to enhancing the operation of a watermark detection program. The invention could be similarly applied to enhancing the operation of programs such as programs the detect geometric shapes such as logos or particular patterns in an image. Likewise the invention could be applied to enhancing the operation of feature extraction programs, such as program for face recognition, fingerprint detection etc. In all these cases the inverse user adjustment program 25 would reverse any changes made as a result of settings entered by the user.

In embodiments that use shape or image recognition the watermark detection program 26 would be replaced by an image or shape recognition program. Alternatively, a shape or image recognition program could be provided in addition to watermark detection program 26 and the output from both such programs would determine the action taken by control block 316.

In an alternate embodiment of the invention, a special tone map is developed with the specific object of enhancing the ability to read a watermark and to detect shapes in a digital image which has been scanned. This special tone map is developed in order to reverse artifacts introduced into an image by a scanner. The special tone map is then either directly applied to the image generated by a scanner or the user adjustment program reverses any changes made to the image that differ from the values in the special tone map.

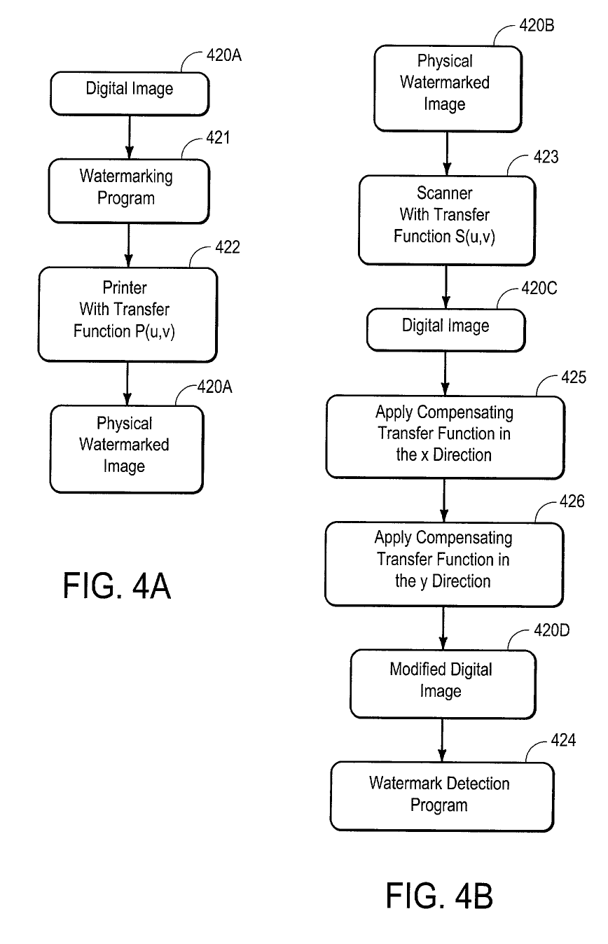

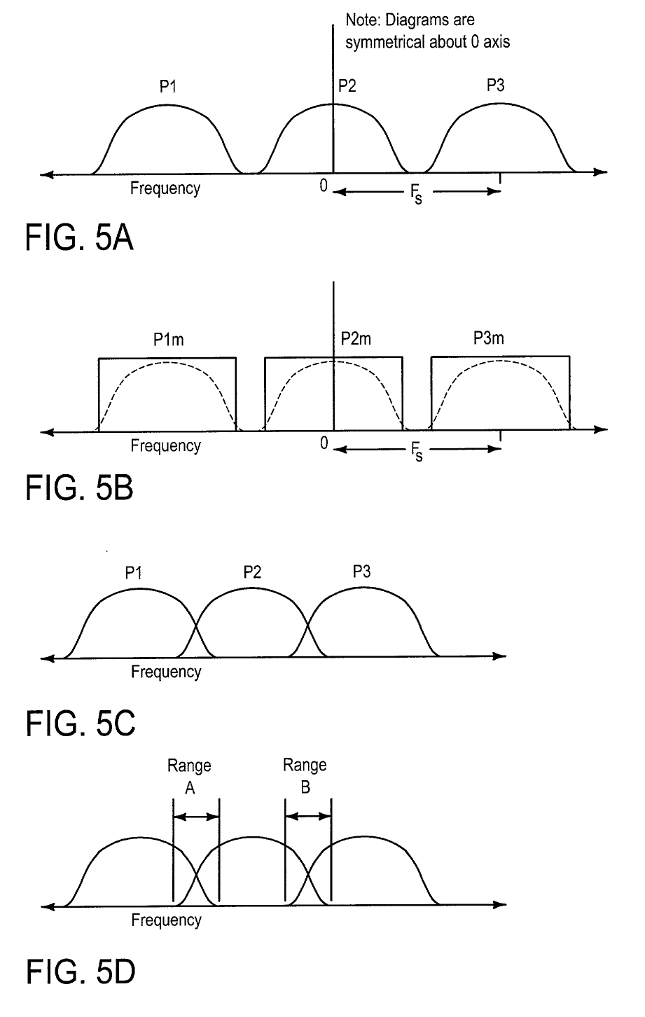

An overall flow diagram for an alternate embodiment of the invention is shown in FIGS. 4A to 5D. The embodiment shown in FIGS. 4A to 5D, takes into consideration the fact that the transfer function of a printer or scanner may differ in the x and y directions. The process begins with a digital image 420A. A watermark is introduced into the image by a watermarking program 421. The watermarking program 421 may for example be the commercially available program “Adobe PhotoShop” which is marketed by the Adobe Corporation. The watermarked image is then printed by a printer 422 resulting in a watermarked physical image 420B

The image 420B is next passed through a scanner 423 to generate a digital image 420C as illustrated in FIG. 4B. The scanner 423 has a transfer function S(u,v) where “u” and “v” are the horizontal and vertical frequency axis. Of particular importance is the fact that the transfer function of scanner 423 differs in the “x” and “y” directions. Furthermore, the transfer function of the scanner is separable in the “u” and “v” dimensions and the transfer function S(u,v) can be represented as S(u) times S(v).

The image 420C is passed through (or operated upon by) a transfer function 425 which approximates as close as possible the inverse of the transfer function S(u). The image is passed through (or operated upon by) a transfer function 426 which approximates as close as possible the inverse of the transfer function S(v). Both of the operations 425 and 426 may be done simultaneously. The technique for designing a filter with a particular transfer function is well know. The result of passing the image through filters 425 and 426 is a modified digital image 420D. The modified digital image 420D is then passed through a conventional watermark detection program 424 in order to detect the watermark.

While the above embodiment relates specifically to compensating for anomalies introduced by scanner 423, the filters 425 and 426 could likewise be designed to compensate for anomalies introduced by the transfer function of the printer 422 or for both the transfer functions of printer 422 and scanner 423.

The second embodiment of the invention described above relates to the use of filters which approximate as close as possible the inverse of the transfer function of a scanner. Such filters of necessity will be relatively complex. A simpler embodiment of the invention is illustrated in FIGS. 5A to 5D.

With reference to FIGS. 5A to 5D, it is specifically noted that an image has a two dimensional frequency spectrum. For convenience in illustration, FIGS. 5A to 5C show one dimensional frequency spectra. That is, the frequency spectrum of an image is in fact two dimensional; however, the principles can be more conveniently illustrated with a diagram that shows a one dimensional frequency spectrum. Hence, FIGS. 5A to 5D show one dimensional spectra; however, it should be understood that in fact they merely illustrate one dimension of a two dimensional spectrum.

A scanning process is of necessity a sampling process. As is well know, a sampling process produces a periodic frequency spectrum. If sampling is at a frequency Fₛ the spectra are separated by Fₛ as shown in FIG. 5A. If the sampling frequency is too low, the frequency spectra will overlap as shown in FIG. 5C.

In the case where the spectra do not overlap such as shown in FIG. 5A, the compensating transfer functions 425 and 426 are designed to enhance the lower frequency components of the signal so that the spectra are relatively square as shown by spectra P1m to P3m in FIG. 5B.

In the situation where the scanner resolution (i.e. for example, the scanner sampling frequency in the X direction) produces a frequency spectrum such as that shown in FIG. 5C, the watermark detection can be improved by filtering out frequency ranges A and B which are shown in FIG. 5D. That is, the compensating transfer function of filter 225 shown in FIG. 4B would be a simple frequency filter which eliminates the frequency in ranges A and B shown in FIG. 5C.

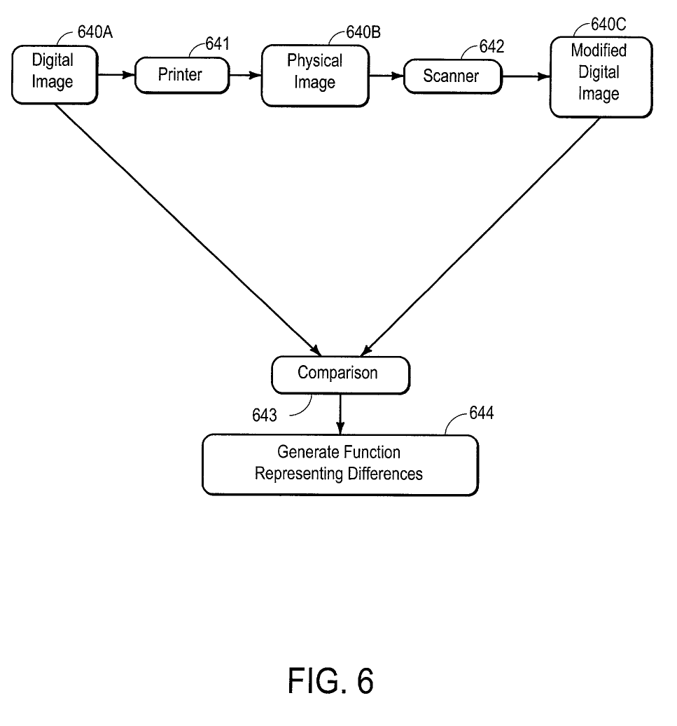

Any printers and any scanner has a transfer functions which is particular to the particular physical characteristics of the printer. In general the manufacturer of a printer or a scanner would best understand the transfer function of a particular printer or scanner. However, if the transfer function of a printer or a scanner can not be obtained from the units manufacturer, it can be determined experimentally. The transfer function of a printer and of a scanner can be determined experimentally in various known ways. One particular technique for determining the transfer function of a printer or of a scanner is shown in FIG. 6. First, a process for determining the transfer function of a scanner 642 will be described.

As illustrated in FIG. 6, the process for experimentally determining a transfer function of scanner 642 begins with a digital image 640A. The image 640A should be printed on a very high quality printer to produce a physical image 640B which as closely as possible is identical to image 640A. The physical image 640B is then scanned by scanner 642 to produce a modified digital image 640C.

Next the original digital image 640A is compared to the modified digital image 640C by a comparison program 643. Any differences between images 640A and 640C represent anomalies introduced by the scanner 642. Stated differently the image 640C is image 640A modified by the transfer functions of scanner 642. In a practical situation, dozens if not hundreds of images will be passed through the process shown in FIG. 6 in order to determine, as closely as possible, the transfer function of a particular scanner.

If one wants to determine the transfer function of a printer, a very high quality scanner can be used in the process illustrated in FIG. 6. In such a case differences between images 640C or 640A would due to anomalies introduced by the printer.

It is noted that instead of using a very high quality printer or scanner as described above, one could use a printer with a known characteristic when seeking to determine the transfer function of a scanner and one could use a scanner with a known transfer function when seeking to determine the transfer function of a printer. The known transfer function of the printer or scanner would then be taken into account when seeking to determine the transfer function of the other component.

The differences detected by comparison program 643 can be used to generate a function or filter that approximates the inverse of the transfer function of a printer 641 or of a scanner 642 or the differences can be used to design a compensating filter as used in the embodiment described with reference to FIGS. 5A to 5D. The differences in the “x” and “y” directions can be processed separately in order to be able to separately compensate for the differences in the “x” and “y” directions.

While the invention has been described with respect to a number of different embodiments of the invention, it will be understood by those skilled in the art that various changes in forma and detail can be made without departing from the spirit and scope of the invention.

I claim:

1. A process and system for improving watermark detection by compensating for artifacts introduced by the printer and/or scanner through which the image has passed prior to detecting a watermark in said image.

2. A process or system for improving watermark detection by applying different compensation to an image in the “x” and “y” (that is, the vertical and horizontal) directions to eliminate anomalies introduced by a printer or scanner which differ in the “x” and “y” directions.

3. In a system that includes a scanner that includes a down loadable tone map, a scanner driver that includes a calibrated tone map for the scanner and user controls which control modification of said calibrated tone map to generate a user adjusted tone map, said scanner generating an image which has been modified by said user controlled tone map,
the improvement comprising a program to reverse the action on said image of the user modifications to said calibrated tone map.

4. A method of reading a watermark or pattern from a digital image generated by a scanner from a hard-copy image, said digital image most nearly matching said hard-copy image when the image generated by said scanner is modified in accordance with a calibrated tone map, said method comprising,
down-loading into said scanner a user modified tone map,
modifying said image in said scanner with said user modified tone map,
transferring said scanner modified image to a computer attached to said scanner,
modifying said modified image with a tone map that reverses any differences between said calibrated tone map and said user modified tone map to generate a reverse modified tone map, and
reading said watermark or detecting said pattern in said image.

5. A method of controlling operations with data carried in a physical image comprising the steps of:
scanning said physical image with a scanner which has an associated calibrated tone map which will compensate for differences between the image generated by said scanner and the characteristics of said physical image,
adjusting said calibrated tone map in accordance with user supplied parameters to produce a user adjusted tone map,
applying said user adjusted tone map to said image to produce a user desired image,
applying a tone map to said user desired image which is the inverse of the changes made to said calibrated tone map to generate said user desired tone map, to generate an image that corresponds to the image generated by said scanner compensated by said calibrated tone map,
reading a characteristics of said image,
controlling said operations with the result of said reading step.

6. The method recited in claim 5 wherein said reading step reads a digital watermark from said image.

7. The method recited in claim 5 wherein said reading step detects a shape in said image.

8. The method recited in claim 5 wherein said reading step reads attempts to both read a digital watermark from said image and to and detects a shape in said object.

9. A method of operating on an image comprising the steps of
generating a first digital image from a physical document,
applying a first tone map to said image to generate an adjusted digital image,
applying an second tone map to said adjusted digital image to generated a corrected digital image, said second tone map adapted to reverse an changes made to said first digital image that differ from changes specified by a calibrated tone map,
operating upon said corrected digital image to determine characteristics of said corrected digital image.

10. The method recited in claim 9 wherein said corrected digital image is operated upon to read a digital watermark from said corrected digital image.

11. The method recited in claim 9 wherein said corrected digital image is operated upon to detect a pattern in from said corrected digital image.

12. A system which includes a scanner which has the ability to apply a tone map to a scanned image, and a data source which calculates a user adjusted tone map by applying to a calibrated tone map user established parameters, said data source having the ability to down load said user adjusted tone map to said scanner, said scanner adapted to applying said user adjusted tone map to said scanned image to generate an adjusted image,
an inverse user adjustment program that generates a corrected image by applying to said adjusted image a tone map that reverses changes made to said calibrated tone map to generate said user adjusted tone map,
program for detecting characteristics of data in said image.

13. The system recited in claim 12 wherein said program for detecting characteristics of data in said image comprises a watermark reading program.

14. The system recited in claim 12 wherein said program for detecting characteristics of data in said image comprises a program for detecting shapes in said image.

15. A system for operating on an image comprising
an image acquisition device for generating a first digital image from a physical document, said image acquisition device applying a first tone map to said image to generate an adjusted digital image,
an inverse user adjustment program for applying a second tone map to said adjusted digital image to generated a corrected digital image, said second tone map adapted to reverse an changes made to said first digital image that differ from changes specified by a calibrated tone map,
a program which operates upon said corrected digital image to determine characteristics of said corrected digital image.

16. The system recited in claim 15 wherein said program which operates upon said corrected image is a watermark reading program.

17. The system recited in claim 15 wherein said program which operates upon said corrected image is a program which detects particular shapes in said corrected image.

18. A system for operating on an image comprising
acquisition means for acquiring a first digital image from a physical document, said acquisition means applying a first tone map to said image to generate an adjusted digital image,
means for applying a second tone map to said adjusted digital image to generated a corrected digital image, said second tone map adapted to reverse an changes made to said first digital image that differ from changes specified by a calibrated tone map,
detection means for operating upon said corrected digital image to determine characteristics of said corrected digital image.

19. The system recited in claim 18 wherein said detection means comprises a watermark reading program.

20. The system recited in claim 18 wherein said acquisition means is a scanner.

21. The system recited in claim 18 wherein said detection means comprises a program to detect a shape in an image.

22. A method of acquiring a digital image from a physical document, scanning said image with a scanner to produce a digital image, said scanner introducing aliasing frequencies into said digital image,
filtering said image to eliminate said aliasing frequencies to produce a corrected digital image.

23. The system recited in claim 18 wherein said acquisition means is a ScanJet 6300 c scanner.

24. A method of creating a digital image that corresponds to an image on a physical document,
scanning said physical document with a scanner to produce a first digital image, the
frequency response of said scanner decreasing at higher frequency values,
filtering said first digital image with a filter which compensates for the frequency response of said scanner.

25. A system which includes a TWAIN compliant scanner which has the ability to apply a tone map to a scanned image, and a TWAIN data source which calculates a user adjusted tone map by applying to a calibrated tone map user established parameters,
said TWAIN data source having the ability to down load to said scanner said user adjusted tone map, said scanner adapted to applying said user adjusted tone map to said scanned image to generate an adjusted image,
an inverse user adjustment program that generates a corrected image by applying to said adjusted image a tone map that reverses changes made to said calibrated tone map to generate said user adjusted tone map,
a computer program for which examines characteristics of said corrected image.

26. The system recited in claim 25 wherein said program is adapted to read a digital watermark in said image.
